(19) United States
(12) Patent Application Publication
(10) Pub. No.: US 2014/0325122 A1
(43) Pub. Date: Oct. 30, 2014

(54) NONVOLATILE MEMORY SYSTEM INCLUDING NONVOLATILE MEMORY DEVICE, MEMORY CONTROLLER AND OPERATING METHOD THEREOF

(71) Applicant: SAMSUNG ELECTRONICS CO., LTD., Gyeonggi-do (KR)

(72) Inventors: Su-Gon KIM, Seoul (KR); Shine Kim, Gyeonggi-do (KR); Seongjun Ahn, Seoul (KR)

(73) Assignee: SAMSUNG ELECTRONICS CO., LTD., Gyeonggi-do (KR)

(21) Appl. No.: 14/219,608

(22) Filed: Mar. 19, 2014

(30) Foreign Application Priority Data
Apr. 30, 2013 (KR) 10-2013-0048479

(51) Int. Cl. G06F 3/06

(52) U.S. Cl. CPC G06F 3/0659; G06F 3/0604; G06F 3/0653; G06F 3/0679
USPC 711/103

(57) ABSTRACT

An operating method of a memory controller that controls a nonvolatile memory device is provided. A command is received from an external device. Whether the nonvolatile memory device is in a temperature control mode is determined. When the nonvolatile memory device is in the temperature control mode, the received command is delayed for a predetermined time until the received command is outputted to the nonvolatile memory device. When the nonvolatile memory device is in the temperature control mode, the nonvolatile memory device is in an idle state.

### CROSS-REFERENCE TO RELATED APPLICATION

This application claims priority under 35 U.S.C. §119 to Korean Patent Application No. 10-2013-0048479, filed on Apr. 30, 2013 in the Korean Intellectual Property Office, the disclosure of which is incorporated herein by reference in its entirety.

### TECHNICAL FIELD

The present inventive concept relates to a nonvolatile memory system including a nonvolatile memory device, a memory controller and an operating method thereof.

### DISCUSSION OF RELATED ART

Nonvolatile memory devices retain stored contents after power is disconnected from the nonvolatile memory devices. The nonvolatile memory devices include a Read Only Memory (ROM) device, a Programmable ROM (PROM) device, an Electrically Programmable ROM (EPROM) device, an Electrically Erasable and Programmable ROM (EEPROM) device, a flash memory device, a Phase-change RAM (PRAM) device, a Magnetic RAM (MRAM) device, a Resistive RAM (PRAM) device, a Ferroelectric RAM (FRAM) device, etc.

When nonvolatile memory devices continue to operate, the temperature of the nonvolatile memory devices increases. Such temperature increase may affect the function of nonvolatile memory devices, and thus a cooling apparatus is provided to control the temperature of electronic devices including nonvolatile memory devices.

### SUMMARY

According to an exemplary embodiment of the present inventive concept, an operating method of a memory controller that controls a nonvolatile memory device is provided. A command is received from an external device. Whether the nonvolatile memory device is in a temperature control mode is determined. When the nonvolatile memory device is in the temperature control mode, the received command is delayed for a predetermined time until the received command is outputted to the nonvolatile memory device. When the nonvolatile memory device is in the temperature control mode, the nonvolatile memory device is in an idle state.

According to an exemplary embodiment of the present inventive concept, a nonvolatile memory system includes a nonvolatile memory device and a memory controller. The memory controller delays, based on an operating mode of the nonvolatile memory device, a command received from an external device for a predetermined time until the received command is outputted to the nonvolatile memory device. The operating mode is determined based on a timeout time and an expected processing time of the received command.

According to an exemplary embodiment of the present inventive concept, an operating method of a memory controller is provided to control a nonvolatile memory device. A temperature of the nonvolatile memory device is measured. Whether the nonvolatile memory device is in a temperature control mode is determined. When the nonvolatile memory device is in the temperature control mode, the nonvolatile memory device is set to be in an idle state for a first period. When a command from an external device is received in the first period of the temperature control mode, the received command is delayed for a predetermined time until the received command is outputted to the nonvolatile memory device.

### BRIEF DESCRIPTION OF THE DRAWINGS

These and other features of the inventive concept will become more apparent by describing in detail exemplary embodiments thereof with reference to the accompanying drawings of which:

FIG. 1 is a block diagram illustrating a nonvolatile memory system according to an exemplary embodiment of the inventive concept;

FIG. 2 is a block diagram illustrating a memory controller according to an exemplary embodiment of the inventive concept;

FIG. 3 is a flowchart illustrating an operation of a memory controller according to an exemplary embodiment of the inventive concept;

FIG. 4 is a detailed flowchart of step S130 illustrated in FIG. 3, according to an exemplary embodiment of the inventive concept;

FIGS. 5 to 9 are timing diagrams illustrating an operation of a memory controller according to an exemplary embodiment of the inventive concept;

FIG. 10 is a block diagram illustrating a nonvolatile memory system according to an exemplary embodiment of the inventive concept;

FIG. 11 is a block diagram illustrating a nonvolatile memory system according to an exemplary embodiment of the inventive concept; and

FIG. 12 is a block diagram illustrating a user system including a memory system according to an exemplary embodiment of the inventive concept.

### DETAILED DESCRIPTION OF THE EXEMPLARY EMBODIMENTS

Exemplary embodiments of the inventive concept will be described below in detail with reference to the accompanying drawings. However, the inventive concept may be embodied in different forms and should not be construed as limited to the embodiments set forth herein. In the drawings, the thickness of layers and regions may be exaggerated for clarity. It will also be understood that when an element is referred to as being “coupled to” or “connected to” another element, it may be directly coupled to or connected to the other element, or intervening elements may also be present. Like reference numerals may refer to the like elements throughout the specification and drawings.

A nonvolatile memory system according to an exemplary embodiment of the present invention may enter a temperature control mode when a temperature of the nonvolatile memory system is higher than a reference temperature. If a command is received from an external device (e.g., a host, an application processor, etc.), the nonvolatile memory system may perform an operation corresponding to the received command after a hold time. Thus, it is possible to provide the nonvolatile memory system that controls a temperature efficiently.

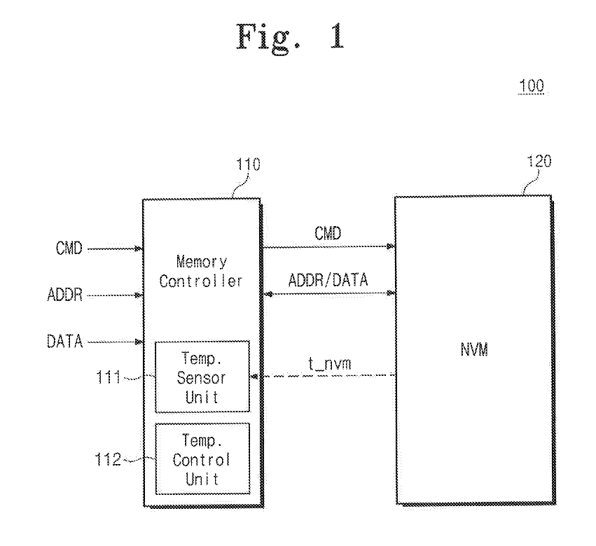

FIG. 1 is a block diagram illustrating a nonvolatile memory system according to an exemplary embodiment of the inventive concept. Referring to FIG. 1, a nonvolatile memory system 100 includes a memory controller 110 and a nonvolatile memory device 120.

The memory controller 110 controls the nonvolatile memory device 120 based on a command CMD, an address ADDR, and data received from an external device (e.g., a host, an application processor, etc.). For example, the memory controller 110 outputs a command CMD, an address ADDR, and data to the nonvolatile memory device 120. The memory controller 110 performs a data reading, writing or erasing operation on the nonvolatile memory device 120 based on the command CMD, the address ADDR and the data. For example, the memory controller interpret or decode a request having a command CMD and/or a logical address ADD from an external device and generate the received command CMD and the physical address ADDR.

The memory controller 110 includes a temperature sensor unit 111 and a temperature control unit 112. The temperature sensor unit 111 measures a temperature T_nvm of the nonvolatile memory device 120. Alternatively, the temperature sensor unit 111 measures a temperature of the nonvolatile memory system 100.

The temperature control unit 112 compares the measured temperature T_nvm of the nonvolatile memory device 120 with a reference temperature T_ref. The temperature control unit 112 controls an operating mode of the nonvolatile memory system 100 based on the comparison result. For example, when the measured temperature T_nvm is lower than the reference temperature T_ref, the nonvolatile memory system 100 operates in a normal mode. The normal mode indicates to a state where the memory controller 110 performs a data writing, reading or erasing operation on the nonvolatile memory device 120.

On the other hand, when the measured temperature T_nvm is higher than the reference temperature T_ref, the temperature control unit 112 may control the nonvolatile memory system 100 to enter a temperature control mode. The temperature control unit 112 may maintain the temperature control mode of the nonvolatile memory system 100 for a predetermined time. The temperature control mode indicates to a mode where the memory controller 110 and the nonvolatile memory device 120 are in an idle state. In the temperature control mode, the memory controller 110 holds the command CMD received from the external device for a hold time T_hold, without issuing the command CMD to the nonvolatile memory device 120. For example, the memory controller 110 also perform operations of receiving a command CMD, an address ADDR and data from the external device, calculating an internal clock, and refreshing a buffer memory.

The hold time T_hold is determined based on a timeout time T_out and an expected processing time T_exp of the input command CMD. For example, the memory controller 110 calculates the hold time T_hold of the input command CMD based on the timeout time T_out and the expected processing time T_exp of the input command CMD.

In exemplary embodiments, the timeout time T_out may be time allocated for an operation corresponding to the input command CMD. For example, when a timeout time of read operation may be 10 cycles of clock, the nonvolatile memory system has to complete the read operation within 10 cycles of clock. If the nonvolatile memory system does not complete the read operation within 10 cycles of clock, the nonvolatile memory system may transmit interrupt signal or fault signal to a host. Thus, the nonvolatile memory system has to complete the operation corresponding to the received command CMD within the timeout time t_out.

In exemplary embodiments, the expected processing time T_exp may be approximate time needed to perform an operation corresponding to the input command CMD. For example, when an expected processing time t_exp of a read operation may 3 cycles of clock CLK, the nonvolatile memory system performs the read operation during 3 cycles of clock. Thus, the expected processing time T_exp may be an actual amount of time of completing an operation corresponding to an external request. In exemplary embodiments, the timeout time T_out may be larger than the expected processing time T_exp.

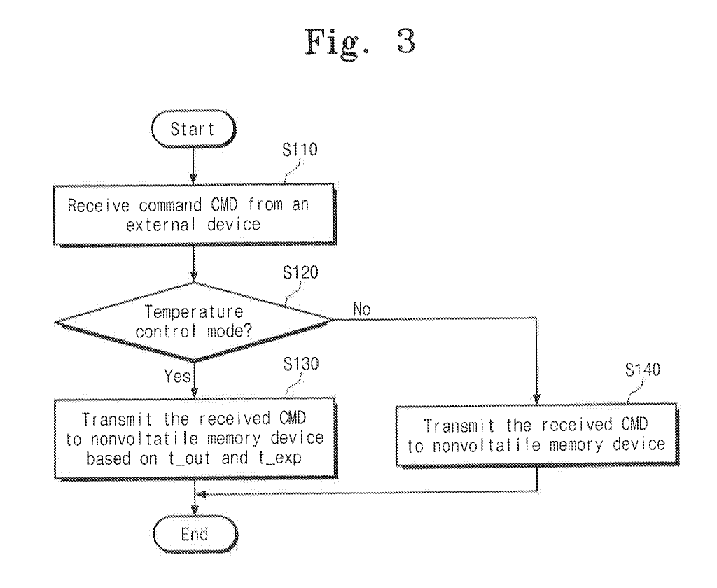

In the temperature control mode, the memory controller 110 receives the input command CMD and issues the input command CMD to the nonvolatile memory device 120 the hold time T_hold after the receipt of the command CMD. The nonvolatile memory device 120 maintains an idle state during the hold time T_hold. Accordingly, the nonvolatile memory system 100 controls temperature efficiently without affecting the performance of the external device. The temperature control mode will be more fully described with reference to FIGS. 3 to 9.

The nonvolatile memory device 120 includes a plurality of memory blocks. Each block includes a plurality of pages. In response to a command CMD received from the memory controller 110, a reading, writing or erasing operation is performed on the nonvolatile memory device 120. When not receiving a command CMD from the memory controller 110, the nonvolatile memory device 120 does not perform a data reading, writing or erasing operation and thus the nonvolatile memory device 120 does not generate heat. The nonvolatile memory device 120 includes, but is not limited to, a NAND flash memory device. For example, the nonvolatile memory device 120 may include a NOR flash memory device, a PRAM (Phase-change Random Access Memory) device, a MRAM (Magnestoresistive Random Access Memory) device, a ReRAM (Resistive Random Access Memory) device and so on.

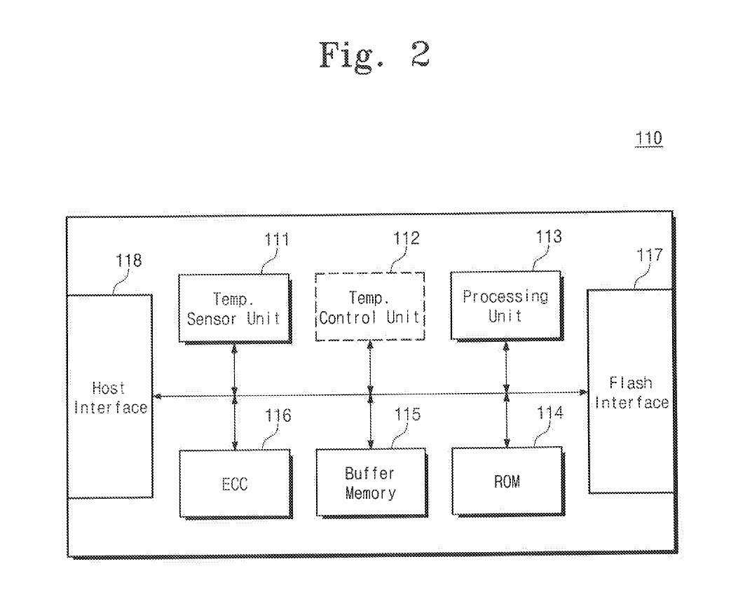

FIG. 2 is a block diagram illustrating a memory controller according to an exemplary embodiment of the inventive concept. Referring to FIGS. 1 and 2, a memory controller 110 includes a temperature sensor unit 111, a temperature control unit 112, a processing unit 113, a ROM (Read Only Memory) 114, a buffer memory 115, an ECC (Error Correcting Code) unit 116, a flash interface 117, and a host interface 118. The temperature sensor unit 111 measures a temperature of the nonvolatile memory device 120.

The temperature control unit 112 compares the measured temperature T_nvm of the nonvolatile memory device 120 with a reference temperature T_ref. The temperature control unit 112 controls an operating mode of the nonvolatile memory system 100 based on the comparison result. For example, when the measured temperature T_nvm is higher than the reference temperature T_ref, the temperature control unit 112 controls the nonvolatile memory system 100 to operate in a temperature control mode. In the temperature control mode, the temperature control unit 112 sends a command CMD received from an external device (e.g., a host, an application processor, etc.) to the nonvolatile memory device 120 after a lapse of a hold time T_hold. In exemplary embodiments, the temperature control unit 112 may measure a timeout time T_out, an expected processing time T_exp, and the hold time T_hold based on an internal clock CLK. The temperature control unit 122 will be described in detail with reference to FIGS. 3 to 9.

The processing unit 113 controls components of the memory controller 110.

The ROM 114 stores information needed for an operation of the nonvolatile memory system 100. For example. For example, the ROM 114 may store information of a timeout time T_out of a command CMD that is received by the nonvolatile memory system 100. The ROM 114 may also store information of an expected processing time T_exp for a command CMD that the nonvolatile memory system 100 receives. The information may be stored in firmware codes.

The buffer memory 115 temporarily stores data read from the nonvolatile memory device 120 or data received from an external device. The buffer memory 115 includes a volatile or nonvolatile random access memory including, but is not limited to, a Dynamic Random Access Memory (DRAM), a Synchronous DRAM (SDRAM), a Static RAM (SRAM), a Double Date Rate SDRAM (DDR SDRAM), a DDR2 SDRAM, a DDR3 SDRAM, a Phase-change RAM (PRAM), a Magnetic RAM (MRAM), a Resistive RAM (RRAM), etc. When the buffer memory includes a volatile memory, the buffer memory 115 performs a self-refresh operation in the temperature control mode.

The ECC unit 116 generates an ECC using data transferred to the nonvolatile memory device 120. The ECC is stored in the nonvolatile memory device 120. The ECC 116 detects an error of data read from the nonvolatile memory device 120 and corrects the detected error based on the ECC stored in the nonvolatile memory device 120.

The flash interface 117 provides an interface between the memory controller 110 and the nonvolatile memory system 120. The host interface 118 provides an interface between the memory controller 110 and an external device (e.g., a host, an application processor, etc.). The host interface 118 provides an interface between the memory controller 110 and the external device using various interface protocols including, but is not limited to, a Universal Serial Bus (USB) interface, a Peripheral Component Interconnection (PCI) interface, a PCI-express (PCI-E) interface, an Advanced Technology Attachment (ATA) interface, a Serial-ATA interface, a Parallel-ATA interface, a Small Computer Small Interface (SCSI), an Enhanced Small Disk Interface (ESDI), or an Integrated Drive Electronics (IDE) interface.

FIG. 3 is a flowchart illustrating an operation of a memory controller according to an exemplary embodiment of the present invention. Referring to FIGS. 1 and 3, in step SI 10, the memory controller 110 receives a command CMD from an external device. For example, the memory controller 110 receives a command CMD for a read, write or erase operation from the external device (e.g., a host, an application processor, etc.).

In step S120, the memory controller 120 determines whether a nonvolatile memory system 100 is in a temperature control mode. For example, the memory controller 110 measures a temperature of the nonvolatile memory device 120. When the measured temperature T_nvm of the nonvolatile memory device 120 is higher than a reference temperature T_ref, the memory controller 110 controls the nonvolatile memory system 100 to enter a temperature control mode.

In the event that the nonvolatile memory system 100 is at the temperature control mode state, in step S130, the memory controller 110 sends the input command CMD to the nonvolatile memory device 120 based on a timeout time T_out and an expected processing time T_exp of the input command CMD. The step S130 is in detail described with reference to FIG. 4.

If the nonvolatile memory system 100 is not in the temperature control mode state, the memory controller 110 proceeds to step S140 to provide the input command CMD to the nonvolatile memory device 120. In response to the input command CMD, the nonvolatile memory device 120 performs a data reading, writing or erasing operation.

If the nonvolatile memory system 100 is in the temperature control mode state, the memory controller 110 delays an operation corresponding to the input command CMD for a hold time T_hod. Accordingly, the performance of the nonvolatile memory system 100 is increased.

FIG. 4 is a flowchart of step S130 of FIG. 3, according to an exemplary embodiment of the inventive concept. Referring to FIGS. 1, 3, and 4, in step S131, a memory controller 110 detects an expected processing time T_exp of an input command CMD. For example, the memory controller 110 may detect the expected processing time T_exp based on an average of operating times of input commands. Alternatively, the memory controller 110 may include information of the expected processing time T_exp of a command CMD provided from an external device (e.g., a host, an application processor, etc.). Or, the memory controller 110 may update the information of the expected processing time T_exp, periodically.

In step S132, the memory controller 110 calculates a hold time T_bold based on a timeout time T_out and an expected processing time T_exp of the input command CMD. For example, the memory controller 110 detects a difference between the timeout time T_out and the expected processing time T_exp as the hold time T_hold. In exemplary embodiments, the memory controller 110 may include timeout time information of the command CMD in a firmware form.

In step S133, the memory controller 110 compares the hold time T_hold with a remaining temperature control mode time T_con′. The remaining temperature control mode time T_con′ indicates a time between a point of time when the memory controller 110 receives the command CMD and a point of time when the temperature control mode ends.

If the hold time T_hold is longer than the remaining temperature control mode time T_con′, the memory controller 110 proceeds to step S135 where the memory controller 110 transmits the input command CMD to the nonvolatile memory device 120 after the remaining temperature control mode time T_con′ elapses. For example, after the temperature control mode of the nonvolatile memory system 100 ends, the memory controller 110 transmits the input command CMD to the nonvolatile memory device 120.

If the hold time T_hold is shorter than the remaining temperature control mode time T_con′, in step S134, the memory controller 110 transmits the input command CMD to the nonvolatile memory device 120 after the remaining temperature control mode time T_con′ elapses. For example, the nonvolatile memory system 100 operates in the temperature control mode for the remaining temperature control mode time T_con′, but the memory controller 110 activates the nonvolatile memory system 100 to send the input command CMD to the nonvolatile memory device 120. An operation corresponding to the input command CMD has to be completed within the timeout time T_out.

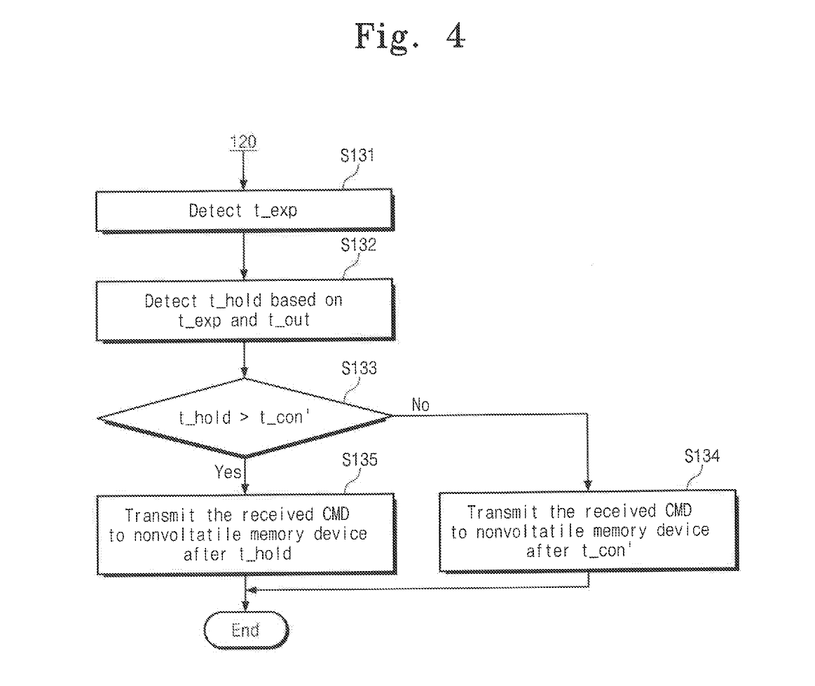

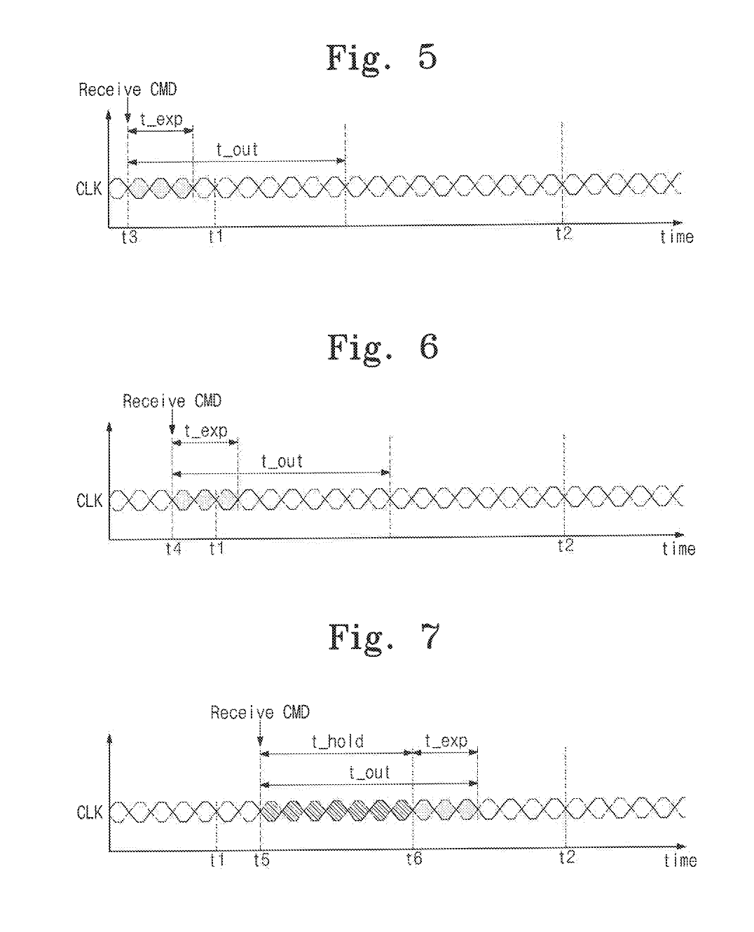

FIGS. 5 to 9 are timing diagrams illustrating an operation of a memory controller according to an exemplary embodiment of the inventive concept. It is assumed that a nonvolatile memory system 100 enters a temperature control mode at t1 when a temperature T_nvm of a nonvolatile memory device 120 is higher than a reference temperature T_ref. And, it is assumed that the temperature control mode is maintained until t2. Also, it is assumed that a timeout time of a command CMD provided to a memory controller 110 corresponds to ten clock cycles. Further, it is assumed that an expected processing time of the command CMD corresponds to three clock cycles. A clock CLK illustrated in FIGS. 5 to 9 is a clock generated by a clock generator (not shown) included in the memory controller 110. However, the inventive concept is not limited thereto,

Referring to FIGS. 1 and 5, at t3, the memory controller 110 receives a command CMD from an external device. In this case, the memory controller 110 transmits the command CMD to a nonvolatile memory device 120 at t3. The nonvolatile memory device 120 performs an operation corresponding to the input command CMD during three cycles of the clock UK from t3. At t1, the nonvolatile memory system 100 enters a temperature control mode. The nonvolatile memory system 100 maintains the temperature control mode until t2. In the temperature control mode, the nonvolatile memory system 100 receives a command CMD from an external device (e.g., a host, an application processor, etc.). However, the nonvolatile memory system 100 does not perform an operation corresponding to the input command CMD for a predetermined time.

Referring to FIGS. 1 and 6, at t4, the memory controller 110 receives a command CMD from the external device, in this case, the memory controller 110 transmits the command CMD received at t4 to the nonvolatile memory device 120. The nonvolatile memory device 120 performs an operation corresponding to the input command CMD during three cycles of the clock CLK from t4. While performing the operation, the nonvolatile memory system 100 enters the temperature control mode at t1. In this case, the temperature control mode does not affect the operation corresponding to the received command CMD, because the nonvolatile memory system 100 enters the temperature control mode after the operation corresponding to the input command CMD is performed. Timing diagrams of FIGS. 5 and 6 corresponds to step S140 of FIG. 3.

Referring to FIGS. 1 and 7, the nonvolatile memory system 100 enters the temperature control mode at t1. The memory controller 110 receives a command CMD at t5 from the external device when the nonvolatile memory system is in the temperature control mode. For example, the memory controller 110 receives the command CMD from the external device under the temperature control mode of the nonvolatile memory system 100. The received command CMD is delayed for a hold time T_hold. The hold time T_hold is determined based on a timeout time T_out and an expected processing time T_exp of the input command CMD. For example, if the timeout time T_out of the input command CMD corresponds to ten clock cycles and the expected processing time T_exp corresponds to three clock cycles, the hold time T_hold correspond to seven clock cycles. The hold time T_hold is defined as the amount of time between when the command CMD is received and when the input command CMD is transmitted to the nonvolatile memory device 120. The hold time T_hold may be expressed by the following equation 1:

t_hold=t_out−t_exp (1)

In the equation (1), ‘T_hold’ indicates a hold time, ‘T_out’ indicates a timeout time, and ‘T_exp’ indicates an expected processing time. For example, since the nonvolatile memory system 100 is at an idle state under the temperature control mode, it does not perform an operation corresponding to the input command CMD. The memory controller 110 transmits the input command CMD to the nonvolatile memory device 120 at t6 when the hold time T_hold elapses from a point of time when the command CMD is received. At t6, the nonvolatile memory system 100 terminates the temperature control mode and enters a normal mode.

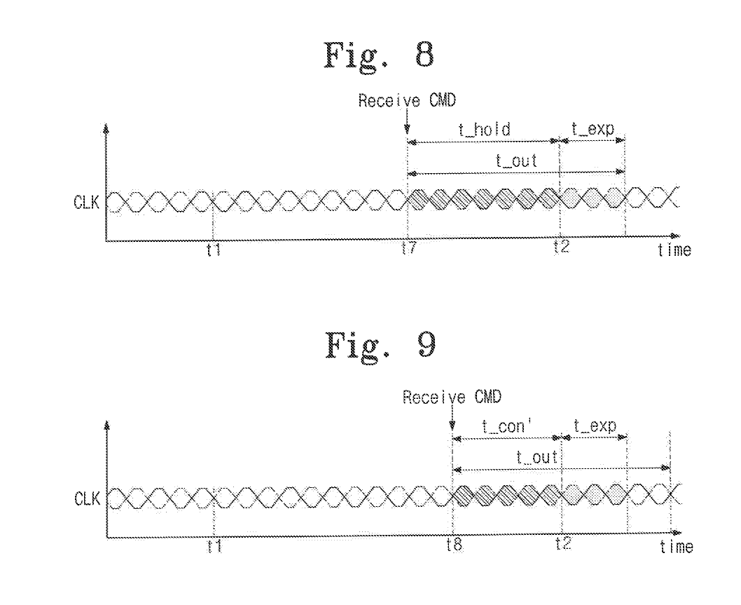

Referring to FIGS. 1 and 8, at t7, the memory controller 110 receives a command CMD from the external device when the nonvolatile memory system 100 is in the temperature control mode. In this case, since the nonvolatile memory system 100 is under the temperature control mode, the memory controller 110 performs an operation corresponding to the input command CMD based on a timeout time T_out and an expected processing time T_exp of the input command CMD. As described with reference to FIG. 6, the memory controller 110 transmits the input command CMD to the nonvolatile memory device 120 at t2 when a hold time T_hold elapses from a point of time when the command CMD is received.

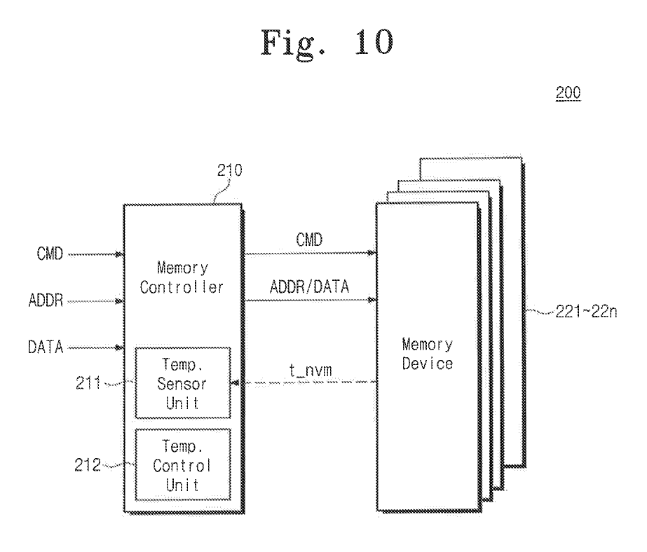

Referring to FIGS. 1 and 9, at t8, the memory controller 110 receives a command CMD from the external device while the nonvolatile memory system 100 is in the temperature control mode. In this case, since the nonvolatile memory system 100 is under the temperature control mode, the memory controller 110 performs an operation corresponding to the input command CMD based on a timeout time T_out and an expected processing time T_exp of the input command CMD.

Unlike cases illustrated in FIGS. 7 and 8, the hold time T_hold is larger than a remaining temperature control mode time T_con′. The remaining temperature control mode time T_con′ is defined as the amount of time between when the input command CMD is received and when the temperature control mode is terminated at t2. For example, the hold time T_hold of the input command CMD corresponds to seven clock cycles. The nonvolatile memory system 100 terminates the temperature control mode before the hold time T_hold elapses. For example, when an input command CMD is received in the temperature control mode, the input command CMD is outputted to the nonvolatile memory device 120 at the earlier of when the hold time T_hold elapse or when the nonvolatile memory system 100 ends its temperature control mode at t2. For example, before the hold time T_hold elapses, the memory controller 110 transmits the command CMD to the nonvolatile memory device 120 at t2 when the nonvolatile memory system 100 terminates the temperature control mode. The memory controller 110 compares the remaining temperature control mode time T_con′ and the hold time T_hold, and the memory controller 110 outputs the input command CMD to the nonvolatile memory device 120 based on the comparison result. Alternatively, the memory controller 110 may terminate the temperature control mode at t2 and output the input CMD to the nonvolatile memory device 120. The timing diagram of Ha 9 corresponds to step S135 of FIG. 4.

As described with reference to FIGS. 5 to 9, when a temperature of the nonvolatile memory device 120 is higher than a reference temperature, the nonvolatile memory system 100 enters the temperature control mode for a temperature control of the nonvolatile memory device 120. The memory controller 110 performs an operation corresponding to an input command CMD according to an exemplary method as described with reference to FIGS. 4 to 9. The nonvolatile memory system 100 efficiently controls a temperature using the temperature control mode. Thus, the performance of the nonvolatile memory system is increased.

FIG. 10 is a block diagram illustrating a nonvolatile memory system according to an exemplary embodiment of the inventive concept. Referring to FIG. 10, a nonvolatile memory system 200 includes a memory controller 210 and a plurality of nonvolatile memory devices 221 to 22n. The memory controller 210 includes a temperature sensor unit 211 and a temperature control unit 212. The memory controller 210 is connected to the nonvolatile memory devices 221 to 22n through a plurality of channels.

The temperature sensor unit 211 measures a temperature of the plurality of nonvolatile memory devices 221 to 22n. The temperature represents an average temperature of the nonvolatile memory devices 221 to 22n.

The temperature control unit 212 decides an operating mode of the nonvolatile memory system 200 based on the measured temperature of the nonvolatile memory system 200. The temperature control unit 212, for example, may operate based on methods as described with reference to FIGS. 1 to 9.

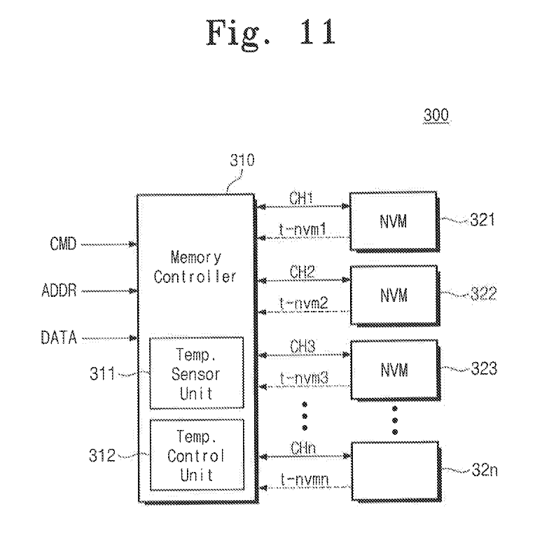

FIG. 11 is a block diagram illustrating a nonvolatile memory system according to an exemplary embodiment of the inventive concept. Referring to FIG. 11, a nonvolatile memory system 300 includes a memory controller 310 and a plurality of nonvolatile memory devices 321 to 32n. The memory controller 310 is connected to the nonvolatile memory devices 321 to 32n through a plurality of channels CH1 to CHn (n being an integer of 2 or more).

Unlike a nonvolatile memory system 200 illustrated in FIG. 10, the nonvolatile memory system 300 illustrated in FIG. 11 is configured such that the nonvolatile memory devices 321 to 32n have different operating modes from one another. For example, the memory controller 310 measures temperatures T_nvm1 to T_nvmn of the nonvolatile memory devices 321 to 32n. The memory controller controls such that a nonvolatile memory device, having a temperature higher than a reference temperature, from among the nonvolatile memory devices 321 to 32n operates in a temperature control mode. In this case, a nonvolatile memory device operating in the temperature control mode may operate based on a method described with reference to FIGS. 1 to 9.

Unlike a nonvolatile memory system 200 illustrated in FIG. 10, the nonvolatile memory system 300 illustrated in FIG. 11 controls the nonvolatile memory devices 321 to 32n to operate in different operating modes from one another. Thus, the nonvolatile memory devices 321 to 32n are independently controlled.

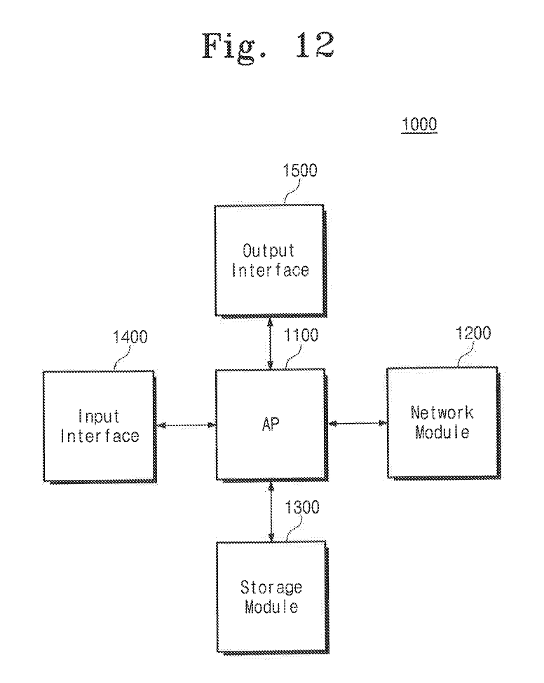

FIG. 12 is a block diagram illustrating a user system including a memory system according to an exemplary embodiment of the inventive concept. For example, a user system 1000 may be one of computing systems such as portable computer, Ultra Mobile PC (UMPC), workstation, net-book, PDA, web tablet, wireless phone, mobile phone, smart phone, e-book, PMP (portable multimedia player), digital camera, a DMB (Digital Multimedia Broadcasting) player, digital audio recorder/player, digital picture/video recorder/player, portable game machine, navigation system, black box, etc.

The user system 1000 includes an application processor 1100, a network module 1200, a storage module 1300, an input interface 1400, and an output interface 1500. The application processor 1100 drives components, an operating system, etc. of the user system 1000. For example, the application processor 1100 may include graphics engines, controllers for controlling components of the user system 1000, interfaces, etc.

The network module 1200 communicates with external devices. For example, the network module 1200 supports wireless communication protocols such as CDMA (Code Division Multiple Access), GSM (Global System for Mobile communication), WCDMA (wideband CDMA), CDMA-2000, TDMA (Time Division Multiple Access), LTE (Long Term Evolution), Wimax, WLAN, UWB, Bluetooth, WI-DI, etc.

The storage module 1300 stores data. For example, the storage module 1300 stores data received from an external device and/or provides data stored therein to the application processor 1100. For example, the storage module 1300 may be implemented by a semiconductor memory device such as a DRAM device, an SDRAM device, an SRAM device, a DDR (Double Data Rate) SDRAM, a DDR2 SDRAM device, a DDR3 SDRAM device, a PRAM, an MRAM, an RRAM, a NAND flash memory, a NOR flash memory or the like. In an exemplary embodiment, the storage module 1300 includes a nonvolatile memory system as described with reference to FIGS. 1 to 11. The storage module 1300 enters a temperature control mode for temperature control. For example, the application processor 1100 controls the storage module 1300 based on methods as described with reference to FIGS. 1 to 10.

The user interface 1400 provides an interface for providing data or commands to the user system 1000. For example, the user interface 1400 may include one of user input interfaces such as a touch screen, a camera, a microphone, an action recognition module, etc. The user interface 1400 may further include one of user output interfaces such as a display, a speaker, a touch screen, etc.

According to an exemplary embodiment of the inventive concept, a nonvolatile memory system operates in a temperature control mode for temperature control. The memory controller maintains the temperature control mode of the nonvolatile memory system by delaying received commands for a predetermined time. Since a temperature of the nonvolatile memory system is controlled, a performance of the nonvolatile memory system is increased.

While the present inventive concept has been shown and described with reference to exemplary embodiments thereof, it will be apparent to those of ordinary skill in the art that various changes in form and detail may be made therein without departing from the spirit and scope of the inventive concept as defined by the following claims.

What is claimed is:

1. An operating method of a memory controller that controls a nonvolatile memory device, the operating method comprising:
receiving a command from an external device;
determining whether the nonvolatile memory device is in a temperature control mode; and
when the nonvolatile memory device being determined to be in the temperature control mode, delaying the received command for a predetermined time until the received command is outputted to the nonvolatile memory device,
wherein when the nonvolatile memory device is in the temperature control mode, the nonvolatile memory device is in an idle state.

2. The operating method of claim 1, wherein the delaying of the received command comprises:
detecting an expected processing time of the received command and a timeout time;
calculating a hold time based on the expected processing time detected and the timeout time;
comparing the hold time and a remaining temperature control mode time of the nonvolatile memory device, wherein if the hold time is greater than the remaining temperature control mode time, the remaining temperature control mode time corresponds to the predetermined time, and if the hold time is less than the remaining temperature control mode time, the hold time corresponds to the predetermined time; and
outputting the received command to the nonvolatile memory device after the predetermined time elapses.

3. The operating method of claim 2, wherein the hold time corresponds to a difference between the expected processing time and the timeout time.

4. The operating method of claim 2, wherein the remaining temperature control mode time is an amount of time between when the command is received and when the temperature control mode of the nonvolatile memory device ends.

5. The operating method of claim 1, wherein the determining of whether the nonvolatile memory device is in the temperature control mode comprises:
measuring a temperature of the nonvolatile memory device; and
comparing the measured temperature of the nonvolatile memory device and a reference temperature,
wherein when the measured temperature is higher than the reference temperature, the nonvolatile memory device is determined to be in the temperature control mode.

6. The operating method of claim I, further comprising:
detecting a temperature of the nonvolatile memory device;
comparing the measured temperature of the nonvolatile memory device and a reference temperature; and
determining, based on the comparison result, that the nonvolatile memory is in the temperature control mode of the nonvolatile memory device.

7. The operating method of claim 6, wherein when the measured temperature of the nonvolatile memory device is higher than the reference temperature, an operating mode of the nonvolatile memory device is controlled in the temperature control mode.

8. A nonvolatile memory system, comprising:
a nonvolatile memory device; and
a memory controller configured to delay, based on an operating mode of the nonvolatile memory device, a command received from an external device for a predetermined time,
wherein the operating mode is determined based on a timeout time and an expected processing time of the received command.

9. The nonvolatile memory system of claim 8, wherein the memory controller comprises:
a temperature sensor unit configured to measure a temperature of the nonvolatile memory device; and
a temperature control unit configured to determine the operating mode using the measured temperature.

10. The nonvolatile memory system of claim 8, wherein the memory controller further comprises:
a ROM configured to store the timeout time and the expected processing time of the received command.

11. The nonvolatile memory system of claim 10, wherein the expected processing time is an amount of time needed to perform an operation corresponding to the received command.

12. The nonvolatile memory system of claim 8, wherein the memory controller is further configured to: calculate a hold time based on the timeout time and the expected processing time of the received command, and compare the hold time measured and a remaining temperature control mode time of the nonvolatile memory system, wherein if the hold time is greater than the remaining temperature control mode time, the remaining temperature control mode time corresponds to the predetermined time, and if the hold time is less than the remaining temperature control mode time, the hold time corresponds to the predetermined time.

13. The nonvolatile memory system of claim 12, wherein the remaining temperature control mode time is an amount of time between when the command is received and when the temperature control mode of the nonvolatile memory device ends.

14. The nonvolatile memory system of claim 12, wherein the memory controller is further configured to output the received command to the nonvolatile memory device after the predetermined time.

15. The nonvolatile memory system of claim 8, wherein the nonvolatile memory device, when in the temperature control mode, is in an idle state.

16. An operating method of a memory controller that controls a nonvolatile memory device, the operating method comprising:
measuring a temperature of the nonvolatile memory device;
determining whether the nonvolatile memory device is in a temperature control mode, wherein when the nonvolatile memory device is in the temperature control mode, the nonvolatile memory device is set to be in an idle state for a first period;
receiving a command from an external device for the first period when the nonvolatile memory device is in the temperature control mode;
delaying the received command for a predetermined time until the received command is outputted to the nonvolatile memory device.

17. The operating method of claim 16, wherein the nonvolatile memory device is determined as being in the temperature control mode when the measured temperature is higher than a reference temperature.

18. The operating method of claim 16, wherein the predetermined time is the smaller of a hold time or a remaining temperature control mode time, wherein the hold time corresponds to a difference between a timeout time and an expected processing time of the received command, wherein the remaining temperature control mode time corresponds to an amount of time between when the command is received and when the temperature control mode of the nonvolatile memory device ends.

19. The operating method of claim 18, further comprising: outputting the received command to the nonvolatile memory device after the predetermined time elapses.

20. The operating method of claim 16, further comprising storing the timeout time and the expected processing time.
